(19) United States
(12) Patent Application Publication
(10) Pub. No.: US 2013/0042451 A1
(43) Pub. Date: Feb. 21, 2013

(54) METHOD FOR BALANCING AN EXHAUST-GAS TURBOCHARGER

(71) Applicant: Udo Dellmann, Lohnsfeld (DE)

(72) Inventor: Udo Dellmann, Lohnsfeld (DE)

(73) Assignee: BORGWARNER INC., Auburn Hills, MI (US)

(21) Appl. No.: 13/643,148

(22) PCT Filed: Apr. 26, 2011
(86) PCT No.: PCT/US11/33834

§ 371 Date: Oct. 24, 2012

(30) Foreign Application Priority Data
Apr. 30, 2010 (DE) 102010018887.5

(51) Int. Cl. B23P 6/00

(52) U.S. Cl. 29/402.01

(57) ABSTRACT

The present invention relates to a method for balancing an exhaust-gas turbocharger, having the following method steps: installing the exhaust-gas turbocharger in a balancing test stand; driving the exhaust-gas turbocharger by loading the turbine with a pressurized fluid; determining the imbalance; and compensating for the determined imbalance. As pressurized fluid for the loading of the turbine, use is made of hot gas which is heated to a temperature of higher than 90° C.

The invention relates to a method for balancing an exhaust-gas turbocharger as per the preamble of claim 1.

At present, the imbalances in exhaust-gas turbochargers are determined after assembly, in so-called balancing test stands. The exhaust-gas turbochargers are driven by means of air from the compressed air operating network. After the measurement of the imbalance, during which the exhaust-gas turbocharger is accelerated to approximately 70% of the maximum operational rotational speed, the imbalance is compensated such that admissible limit values are attained.

During said imbalance measurement in the exhaust-gas turbocharger, however, it is not possible to cover the entire rotational speed range encountered in the vehicle without risking component damage to the bearing arrangement or icing of the turbine. This is because, when using relatively cold air from the compressed air operating networks, the temperature of which is approximately 50° C., the pressure drop in the turbine can result in such intense cooling of said compressed air at the turbine outlet that said icing occurs.

An increase in rotational speed may duly be attained in principle by increasing the pressure of the driving air, but this is associated with inadmissibly high axial forces, which may lead to predamage or damage to the bearing arrangement.

It is therefore an object of the present invention to provide a method for balancing an exhaust-gas turbocharger as per the preamble of claim 1, which method covers the entire rotational speed range encountered, such that all imbalances can be compensated.

Said object is achieved by means of the features of claim 1.

The subclaims relate to advantageous refinements of the invention.

By supplying hot gas to the balancing test stands, a considerably higher enthalpy gradient is obtained for driving the exhaust-gas turbocharger. By means of this method step, the exhaust-gas turbocharger can be driven and balanced in particular up to its maximum rotational speed, that is to say over the entire rotational speed range encountered in the vehicle.

It is therefore possible to avoid the increased bearing loading and to provide a considerably improved method which improves the acoustic behavior generated by the imbalance over the entire rotational speed range.

The subclaims relate to advantageous refinements of the invention.

In detail, it is provided according to the invention that, in a first step, the exhaust-gas turbocharger is installed in a balancing test stand, in which the imbalance is measured. By loading the turbine with a pressurized fluid and connecting the exhaust-gas turbocharger to an oil circuit and throttling the compressor such that its power consumption is low, the exhaust-gas turbocharger undergoes a run-up in the next method step. In the subsequent method steps, the imbalance states at different rotational speeds of the exhaust-gas turbocharger are measured, and the determined imbalance is subsequently compensated.

Hot gas is used as pressurized fluid for driving the exhaust-gas turbocharger, with the hot gas being heated to a temperature of higher than 90° C.

By using hot gas, the exhaust-gas turbocharger is driven over the entire rotational speed range encountered in a motor vehicle, and therefore all the imbalances occurring in said range can also be compensated.

Here, the measurement may take place either with the complete exhaust-gas turbocharger, or preferably only with the body group of the exhaust-gas turbocharger, using test stand housings for the compressor and turbine in the balancing test stands.

1. A method for balancing an exhaust-gas turbocharger, having the following method steps:
installing the exhaust-gas turbocharger in a balancing test stand;
driving the exhaust-gas turbocharger by loading the turbine with a pressurized fluid;
determining the imbalance; and
compensating for the determined imbalance;
wherein
hot gas is used as pressurized fluid.

2. The method as claimed in claim 1, wherein the hot gas is heated to a temperature of higher than 90° C.

3. The method as claimed in claim 1, wherein the exhaust-gas turbocharger is driven and balanced over the entire rotational speed range encountered in a motor vehicle.

4. The method as claimed in claim 1, wherein the exhaust-gas turbocharger is driven and balanced up to its maximum admissible operational rotational speed.
